(19) United States
(12) Patent Application Publication
(10) Pub. No.: US 2017/0180951 A1
(43) Pub. Date: Jun. 22, 2017

(54) SELECTIVE PRIORITIZATION OF EVOLVED MULTIMEDIA BROADCAST MULTICAST SERVICES IN CONCURRENT RADIO ACCESS TECHNOLOGY MOBILE COMMUNICATION DEVICES

(71) Applicant: QUALCOMM Incorporated, San Diego, CA (US)

(72) Inventors: Kuo-Chun Lee, San Diego, CA (US); Sivaramakrishna Veerepalli, San Diego, CA (US); Shailesh Maheshwari, San Diego, CA (US); Mohan Krishna Gowda, San Diego, CA (US); Srinivasan Rajagopalan, San Diego, CA (US); Adrian Prentice, Carlsbad, CA (US); Hans Agardh, La Jolla, CA (US); Nagaraju Naik, San Diego, CA (US); Ralph Akram Gholmieh, San Diego, CA (US)

(21) Appl. No.: 15/045,542

(22) Filed: Feb. 17, 2016

Related U.S. Application Data
(60) Provisional application No. 62/268,322, filed on Dec. 16, 2015.

(51) Int. Cl. H04W 4/06; H04W 72/08; H04W 68/02

(52) U.S. Cl. CPC H04W 4/06; H04W 68/02; H04W 72/087; H04L 12/189

(57) ABSTRACT

A method for selectively prioritizing eMBMS includes: determining a collision metric associated with at least one of a plurality of eMBMS data streams on the first subscription; identifying a first eMBMS data stream of the plurality of eMBMS data streams having a highest collision metric amongst the plurality of eMBMS data streams on the first subscription; assigning the first eMBMS data stream with a higher QoS priority than a QoS priority assigned to paging occasions on the second subscription; and in response to detecting that an upcoming paging occasion on the second subscription coincides with an upcoming eMBMS data burst associated with the first eMBMS data stream on the first subscription, utilizing the RF chain to receive the eMBMS data burst on the first subscription based on the first eMBMS data stream on the first subscription having a higher QoS priority than the paging occasions on the second subscription.

### BACKGROUND

Evolved multimedia broadcast multicast service (eMBMS) is a point-to-multipoint content distribution mechanism. For example, in a Long Term Evolution (LTE) mobile communication network, one or more Evolved Universal Mobile Telecommunications System (UMTS) Terrestrial Radio Access (E-UTRA) Node Bs (eNodeBs) may provide synchronized delivery of identical content (e.g., video) to multiple user equipment (UE) within a single multimedia broadcast single frequency network (MBSFN) area.

The length of a paging cycle (e.g., 2.56 seconds) in a code division multiple access (CDMA) (e.g., lx Radio Transmission Technology (1×RTT)) mobile communication network may be a multiple of the duration (e.g., 320 milliseconds) of a multicast channel (MCH) scheduling period (MSP) in an LTE mobile communication network. Consequently, paging occasions on a CDMA (e.g., 1×RTT) subscription may coincide with eMBMS data bursts on an LTE subscription.

In a concurrent radio access technology (CRAT) mobile communication device (e.g., a multi subscriber identity module (SIM) multi standby (MSMS) mobile communication device), at least some subscriptions may share a single radio frequency (RF) chain. At any time, only one radio access technology (RAT) can use the RF chain which can result in lost LTE data or 1×RTT page messages. As such, when a paging occasion on the CDMA (e.g., 1×RTT) subscription coincides with an eMBMS data burst on the LTE subscription, the CRAT mobile communication device may resolve the collision based on the respective Quality of Service (QoS) priorities associated with the reception of eMBMS data on the LTE subscription and with the reception of paging messages on the CDMA (e.g., 1×RTT) subscription.

As a CRAT mobile communication device may simultaneously receive multiple eMBMS data streams, assigning a higher QoS priority to every eMBMS data stream on the LTE subscription may block page reception on the CDMA (e.g., 1×RTT) subscription and cause an excessive number of missed paging messages. Conversely, always prioritizing paging occasions on the CDMA (e.g., 1×RTT) subscription may cause significant eMBMS data loss on the LTE subscription and degrade the quality of content delivered via eMBMS. An eMBMS service with no QoS may have a lower priority than 1×RTT page and may lose RF resources when there is collision with a 1×RTT page occasion.

### SUMMARY

Apparatuses and methods for selective prioritization of eMBMS in CRAT mobile communication devices are provided.

According to the various embodiments, there is provided a method for selectively prioritizing eMBMS by a mobile communication device having an RF chain associated with a first subscription and a second subscription. The method may include: determining a collision metric associated with at least one of a plurality of eMBMS data streams received on the first subscription; identifying a first eMBMS data stream of the plurality of eMBMS data streams (or services) having a highest collision metric amongst the plurality of eMBMS data streams received on the first subscription; assigning the first eMBMS data stream with a higher QoS priority than a QoS priority assigned to paging occasions on the second subscription; detecting that an upcoming paging occasion on the second subscription coincides with an upcoming eMBMS data burst associated with the first eMBMS data stream on the first subscription; and in response to detecting that an upcoming paging occasion on the second subscription coincides with an upcoming eMBMS data burst associated with the first eMBMS data stream on the first subscription, utilizing the RF chain to receive the eMBMS data burst associated with the first eMBMS data stream on the first subscription based at least in part on the first eMBMS data stream on the first subscription having a higher QoS priority than the paging occasions on the second subscription.

According to the various embodiments, there is provided a mobile communication device. In some embodiments, the mobile communication device may include a control unit; a memory operably connected to said RF chain; and an RF chain.

The control unit may be operably connected to said RF chain and configured to: determine a collision metric associated with at least one of a plurality of eMBMS data streams received on a first subscription; identify a first of the plurality of eMBMS data streams having a highest collision metric amongst the plurality of eMBMS data streams received on the first subscription; assign the first eMBMS data stream with a higher QoS priority than a QoS priority assigned to paging occasions on a second subscription; detect that an upcoming paging occasion on the second subscription coincides with an upcoming eMBMS data burst associated with the first eMBMS data stream on the first subscription; and in response to detecting that an upcoming paging occasion on the second subscription coincides with an upcoming eMBMS data burst on the first subscription, utilize the RF chain to receive the eMBMS data burst associated with the first eMBMS data stream on the first subscription based at least in part on the first eMBMS data stream on the first subscription having a higher QoS priority than the paging occasions on the second subscription.

According to the various embodiments, there is provided a method for selectively prioritizing eMBMS by a mobile communication device having an RF chain associated with a first subscription and a second subscription. The method may include: determining a collision metric associated with a first eMBMS data stream received on the first subscription; determining whether the collision metric associated with the first eMBMS data stream exceeds a threshold value; in response to determining that the collision metric associated with the first eMBMS data stream exceeds the threshold value, assigning the first eMBMS data stream with a higher QoS priority than a QoS priority assigned to paging occasions on the second subscription; detecting that an upcoming paging occasion on the second subscription coincides with an upcoming eMBMS data burst associated with the first eMBMS data stream on the first subscription; and allocating the RF chain to be utilized for one of the upcoming paging occasion and the upcoming eMBMS data burst based at least in part on the respective QoS priorities assigned to the first eMBMS data stream on the first subscription and the paging occasions on the second subscription.

According to the various embodiments, there is provided a mobile communication device. In some embodiments, the mobile communication device may include a radio frequency (RF) chain; a memory operably connected to said RF chain; and a control unit operably connected to said RF chain.

The control unit may be configured to: determine a collision metric associated with a first eMBMS data stream received on the first subscription; determine whether the collision metric associated with the first eMBMS data stream exceeds a threshold value; in response to determining that the collision metric associated with the first eMBMS data stream exceeds the threshold value, assign the first eMBMS data stream with a higher quality of service (QoS) priority than a QoS priority assigned to paging occasions on the second subscription; detect that an upcoming paging occasion on the second subscription coincides with an upcoming eMBMS data burst associated with the first eMBMS data stream on the first subscription; and allocate the RF chain to be utilized for one of the upcoming paging occasion and the upcoming eMBMS data burst based at least in part on the respective QoS priorities assigned to the first eMBMS data stream on the first subscription and the paging occasions on the second subscription.

Other features and advantages of the present disclosure should be apparent from the following description which illustrates by way of example aspects of the present disclosure.

### BRIEF DESCRIPTION OF THE DRAWINGS

Aspects and features of the present disclosure will be more apparent by describing example embodiments with reference to the accompanying drawings, in which:

FIG. 1 is a block diagram illustrating a mobile communication device according to various embodiments;

FIG. 2A is a timeline illustrating an eMBMS schedule according to various embodiments;

FIG. 2B is a timeline illustrating a paging schedule according to various embodiments;

FIG. 3A is a timeline illustrating an eMBMS schedule according to various embodiments;

FIG. 3B is a timeline illustrating a paging schedule according to various embodiments;

FIG. 4 is a flowchart illustrating a process for selectively prioritizing eMBMS according to various embodiments; and

FIG. 5 is a flowchart illustrating a process for selectively prioritizing eMBMS according to various embodiments.

### DETAILED DESCRIPTION

While a number of embodiments are described herein, these embodiments are presented by way of example, and are not intended to limit the scope of protection. The apparatuses and methods described herein may be embodied in a variety of other forms. Furthermore, various omissions, substitutions, and changes in the form of the example apparatuses and methods described herein may be made without departing from the scope of protection.

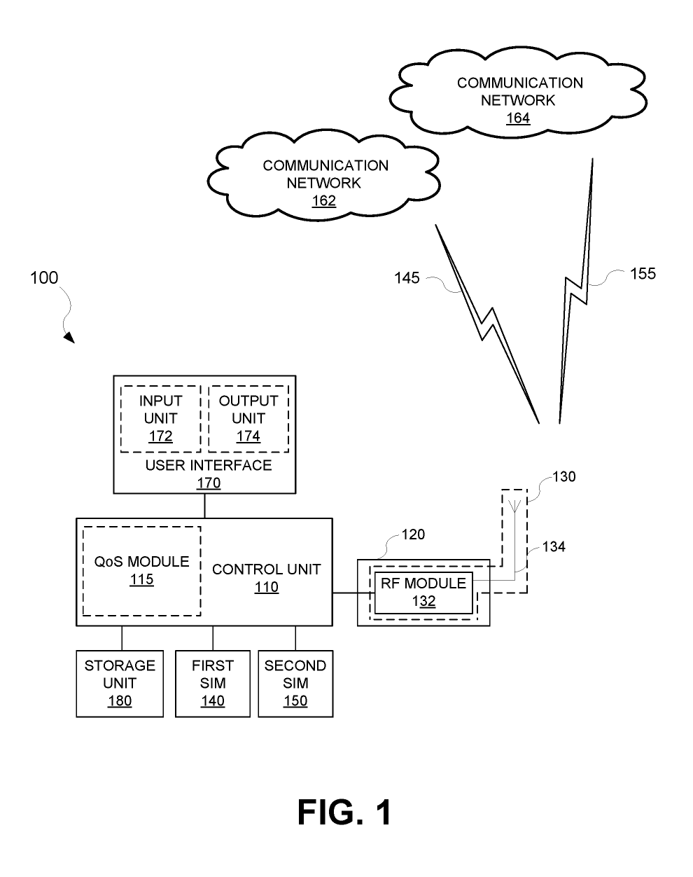

FIG. 1 is a block diagram illustrating a mobile communication device 100 according to various embodiments. Referring to FIG. 1, in various embodiments, the mobile communication device 100 may include a control unit 110, a communication unit 120, a first SIM 140, a second SIM 150, a user interface 170, and storage unit 180.

In various embodiments, the mobile communication device 100 may be any device capable of wirelessly communicating with one or more communication networks including, for example, but not limited to, a first communication network 162 and a second communication network 164. In various embodiments, the mobile communication device 100 may be, for example, but not limited to, a smartphone, a tablet personal computer (PC), or a laptop computer.

In various embodiments, a SIM (e.g., the first SIM 140 and/or the second SIM 150) may be a Universal Integrated Circuit Card (UICC) that is configured with SIM and/or Universal SIM (USIM) applications and enabling access to a Global System for Mobile communications (GSM) and/or a Universal Mobile Telecommunications System (UMTS) mobile communication network. The UICC may also provide storage for a phone book and other applications. Alternatively, in a Code Division Multiple Access (CDMA) mobile communication network, a SIM may be a UICC removable user identity module (R-UIM) or a CDMA subscriber identity module (CSIM) on a card. A SIM card may have a central processing unit (CPU), read-only memory (ROM), random-access memory (RAM), electrically erasable programmable read-only memory (EEPROM), and input/output (I/O) circuits. An Integrated Circuit Card Identity (ICCID) SIM serial number may be printed on the SIM card for identification. However, a SIM may be implemented within a portion of memory of the mobile communication device 100, and thus need not be a separate or removable circuit, chip, or card.

A SIM used in various embodiments may store user account information, an International Mobile Subscriber Identity (IMSI), a set of SIM application toolkit (SAT) commands, and other network provisioning information, as well as provide storage space for phone book database of the user's contacts. As part of the network provisioning information, a SIM may store home identifiers (e.g., a System Identification Number (SID)/Network Identification Number (NID) pair, a Home Public Land Mobile Network (HPLMN) code, etc.) to indicate the SIM card network operator provider.

In various embodiments, the communication unit 120 may include an RF chain 130. The RF chain 130 may include, for example, but not limited to, an RF module 132 and an antenna 134. Although the mobile communication device 100 is shown to include a single communication unit (e.g., the communication unit 120), a person of ordinary skill in the art can appreciate that the mobile communication device 100 may include additional communication units without departing from the scope of the present disclosure.

In various embodiments, the first SIM 140 may associate the communication unit 120 with a first subscription 145 on the first communication network 162, and the second SIM 150 may associate the communication unit 120 with a second subscription 155 on the second communication network 164. For clarity and convenience, throughout this disclosure, the first subscription 145 is associated with the first SIM 140 while the second subscription 155 is associated with the second SIM 150. However, a person having ordinary skill in the art can appreciate that either subscription may be associated with either SIM without departing from the scope of the present disclosure. Moreover, a person having ordinary skill in the art can appreciate that the mobile communication device 100 may include additional SIMs associating the communication unit 120 with additional subscriptions on the same or additional communication networks without departing from the scope of the present disclosure.

In various embodiments, the first communication network 162 and the second communication network 164 may be operated by the same or different mobile service providers. Additionally, in various embodiments, the first communication network 162 and the second communication network 164 may each implement the same or different RATs. For example, the first communication network 162 may be an LTE communication network and the second communication network 164 may be a CDMA (e.g., 1×RTT) communication network. However, a person having ordinary skill in the art can appreciate that the first communication network 162 and the second communication network 164 may each implement a different radio access technology (RAT) including, for example, but not limited to Wideband CDMA (WCDMA), Time Division-Synchronous Code Division Multiple Access (TD-SCDMA), and Long Term Evolution (LTE), without departing from the scope of the present disclosure.

In various embodiments, the user interface 170 may include an input unit 172. In some embodiments, the input unit 172 may be, for example, but not limited to, a keyboard or a touch panel. In various embodiments, the user interface 170 may include an output unit 174. In some embodiments, the output unit 174 may be, for example, but not limited to, a liquid crystal display (LCD) or a light emitting diode (LED) display. A person of ordinary skill in the art will appreciate that other types or forms of input and output units may be used without departing from the scope of the present disclosure.

In various embodiments, the control unit 110 may be configured to control the overall operation of the mobile communication device 100 including controlling the functions of the communication unit 120. In various embodiments, the control unit 110 may include a QoS module 115 configured to assign QoS priorities to activities on the first subscription 145 and the second subscription 155. For example, the QoS module 115 may be configured to selectively assign QoS priority to the reception of one or more eMBMS data streams on the first subscription 145 (or the second subscription 155). In various embodiments, the control unit 110 may be, for example, but not limited to, a microprocessor (e.g., general-purpose processor, baseband modem processor) or a microcontroller.

In various embodiments, the storage unit 180 may be configured to store application programs, application data, and user data. In various embodiments, at least some of the application programs stored at the storage unit 180 may be executed by the control unit 110 for the operation of the mobile communication device 100.

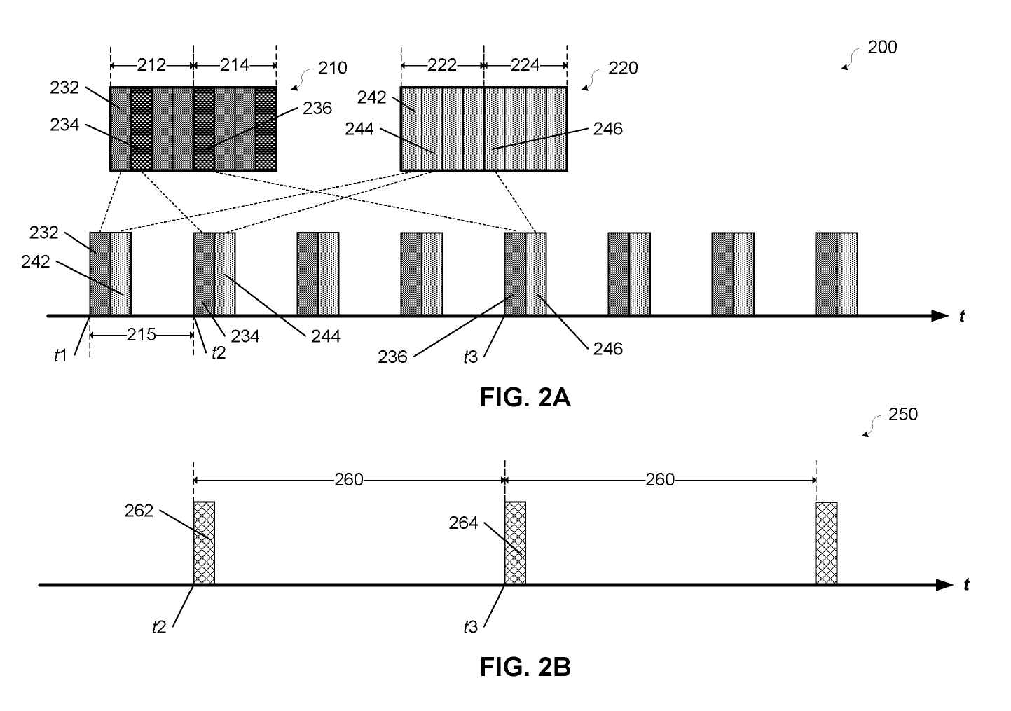

FIG. 2A is a timeline illustrating an eMBMS schedule 200 according to various embodiments. Referring to FIGS. 1 and 2A, in various embodiments, the first communication network 162 may broadcast a plurality of eMBMS data streams including, for example, but not limited to, a first eMBMS data stream 210 and a second eMBMS data stream 220.

The first communication network 162 may broadcast a plurality of eMBMS data bursts associated with the first eMBMS data stream 210 (or service) including, for example, but not limited to, a first data burst 232, a second data burst 234, and a third data burst 236. According to the eMBMS schedule 200, the first communication network 162 may broadcast the first data burst 232 at a first time t1, the second data burst 234 at a second time t2, and the third data burst 236 at a third time t3. The first communication network 162 may also broadcast a plurality of eMBMS data bursts associated with the second eMBMS data stream 220 (or service) including, for example, but not limited to, a fourth data burst 242, a fifth data burst 244, and a sixth data burst 246. The mobile communication device 100 may receive more than one service simultaneously, for example, when a user views multiple videos. In one example, the first eMBMS data stream 210 may be a first video and the second eMBMS data stream 220 may be a second video. Alternatively, the mobile communication device 100 may receive multiple services, but may not render all of the services in order to speed up channel switching time.

In various embodiments, the length of an MSP associated with an eMBMS data stream may be a length of time (e.g., 320 milliseconds) between two consecutive data bursts of the eMBMS data stream. As such, the length of an MSP 215 associated with the first eMBMS data stream 210 may be the length of time (e.g., 320 milliseconds) between the broadcast of the first data burst 232 at t1 and the broadcast of the second data burst 234 at t2.

Each eMBMS data stream may include a plurality of segments of data (e.g., video) formed from consecutive eMBMS data bursts associated with each eMBMS data stream. For example, the first eMBMS data stream 210 may include a plurality of data segments including, for example, but not limited to, a first segment 212 and a second segment 214. The first segment 212 of the first eMBMS data stream 210 may include a plurality of consecutive eMBMS data bursts from the first eMBMS data stream 210 including, for example, but not limited to, the first data burst 232 and the second data burst 234. The second segment 214 of the first eMBMS data stream 210 may also include a plurality of eMBMS data bursts including, for example, but not limited to, the third data burst 236. In various embodiments, segments of data from the same eMBMS data stream may have the same duration (e.g., n seconds). As such, the first segment 212 may be the same length (e.g., n seconds) as the second segment 214.

The second eMBMS data stream 220 may also include a plurality of segments of data (e.g., video) including, for example, but not limited to, a third segment 222 and a fourth segment 224. The third segment 222 of the second eMBMS data stream 220 may include a plurality of consecutive eMBMS data bursts from the second eMBMS data stream 220 including, for example, but not limited to, the fourth data burst 242 and the fifth data burst 244. The fourth segment 224 of the second eMBMS data stream 220 may include a plurality of eMBMS data bursts including, for example, but not limited to, the sixth data burst 246. In various embodiments, the third segment 222 may have a same length (e.g., n seconds) as the fourth segment 224. Moreover, segments of data from different eMBMS data streams may have the same length (e.g., n seconds). As such, the first segment 212 may have the same length (e.g., n seconds) as the second segment 214, the third segment 222, and the fourth segment 224.

Although the eMBMS schedule 200 includes eMBMS data bursts associated with two eMBMS data streams (e.g., the first eMBMS data stream 210 and the second eMBMS data stream 220), the first communication network 162 may broadcast eMBMS data bursts associated with additional eMBMS data streams without departing from the scope of the present disclosure.

FIG. 2B is a timeline illustrating a paging schedule 250 according to various embodiments. Referring to FIGS. 1 and 2A-B, in various embodiments, the second communication network 164 may transmit paging messages according to the paging schedule 250.

The second communication network 164 may transmit paging messages during a plurality of paging occasions including, for example, but not limited to, a first paging occasion 262 and a second paging occasion 264. In various embodiments, the length of a paging cycle 260 (e.g., 2.56 seconds) associated with the second communication network 164 may be a length of time between two consecutive paging occasions. For example, the length of the paging cycle 260 may be a length of time between the first paging occasion 262 and the second paging occasion 264.

The length of the paging cycle 260 (e.g., 2.56 seconds) associated with the second communication network 164 may be a multiple of the length of the MSP 215 (e.g., 320 milliseconds) associated with the first communication network 162. As such, paging occasions on the second communication network 164 may coincide with at least some of the eMBMS data bursts broadcast by the first communication network 162. During a paging occasion, the mobile communication device 100 may tune-away from receiving an eMBMS data stream on the first subscription 145 in order to utilize the RF chain 130 to receive paging messages on the second subscription 155.

Each of the first eMBMS data stream 210 and the second eMBMS data stream 220 may be associated with a collision metric. In various embodiments, the collision metric associated with an eMBMS data stream may include one or more of an amount (e.g., bytes) of eMBMS data, a length of eMBMS reception time, and a number of eMBMS sub-frames that were lost due to tune-aways to the second subscription 155.

In some embodiments, paging occasions on the second communication network 164 may coincide with more eMBMS data bursts associated with the first eMBMS data stream 210 than with eMBMS data bursts associated with the second eMBMS data stream 220. For example, the first paging occasion 262 and the second data burst 234 may both be scheduled at t2. The second paging occasion 264 and the third data burst 236 may both be scheduled at t3. As such, tuning away to the second subscription 155 based on the paging schedule 250 may increase the collision metric associated with the first eMBMS data stream 210, but not the collision metric associated with the second eMBMS data stream 220. For example, the first eMBMS data stream 210 may be associated with one or more of a larger amount of lost eMBMS data, a longer length of lost eMBMS reception time, and a greater number of lost eMBMS sub-frames than the second eMBMS data stream 220.

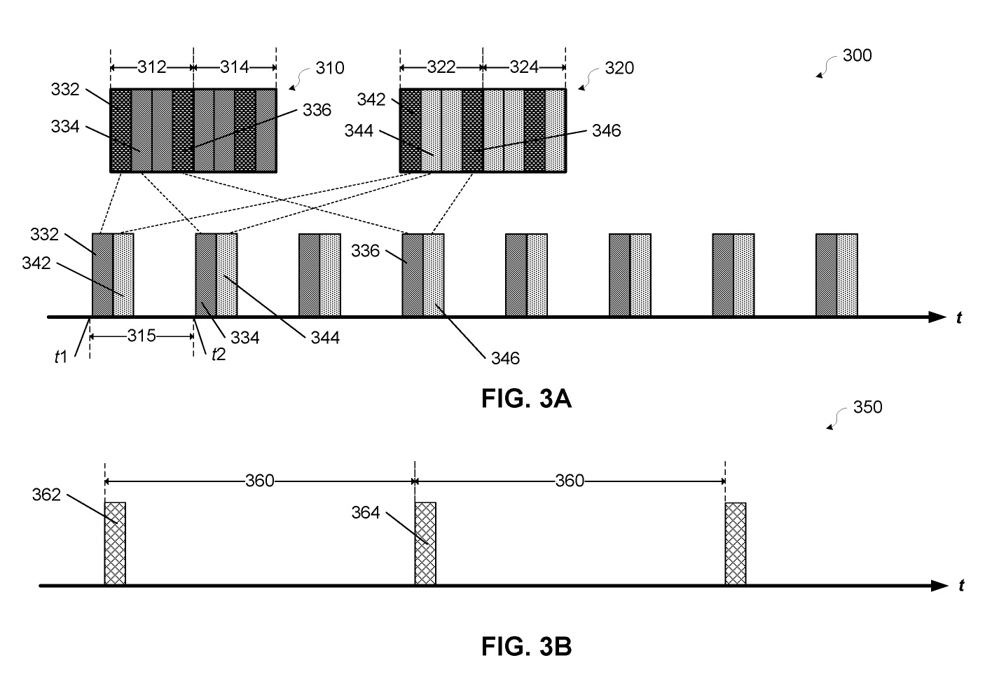

FIG. 3A is a timeline illustrating an eMBMS schedule 300 according to various embodiments. Referring to FIGS. 1 and 3A, in various embodiments, the first communication network 162 may broadcast a plurality of eMBMS data streams including, for example, but not limited to, a first eMBMS data stream 310 and a second eMBMS data stream 320.

The first communication network 162 may broadcast a plurality of eMBMS data bursts associated with the first eMBMS data stream 310 including, for example, but not limited to, a first data burst 332 (e.g., at a first time t1), a second data burst 334 (e.g., at a second time t2), and a third data burst 336. The first communication network 162 may also broadcast a plurality of eMBMS data bursts associated with the second eMBMS data stream 320 including, for example, but not limited to, a fourth data burst 342, a fifth data burst 344, and a sixth data burst 346.

The length of an MSP 315 associated with the first communication network 162 may be a length of time between two consecutive eMBMS data bursts in an eMBMS data stream. For example, the length of the MSP 315 may be a length of time between the first data burst 332 at t1 and the second data burst 334 at t2.

The first eMBMS data stream 310 may include a plurality of segments of data (e.g., video) including, for example, but not limited to, a first segment 312 and a second segment 314. For example, the first segment 312 may be formed from consecutive eMBMS data bursts associated with the first eMBMS data stream 310 including, for example, but not limited to, the first data burst 332, the second data burst 334, and the third data burst 336.

The second eMBMS data stream 320 may also include a plurality of segments of data (e.g., video) including, for example, but not limited to, a third segment 322 and a fourth segment 324. For example, the third segment 322 may be formed from consecutive eMBMS data bursts associated with the second eMBMS data stream 320 including, for example, but not limited to, the fourth data burst 342, the fifth data burst 344, and the sixth data burst 346.

Although the eMBMS schedule 300 includes eMBMS data bursts associated with two eMBMS data streams (e.g., the first eMBMS data stream 310 and the second eMBMS data stream 320), the first communication network 162 may broadcast eMBMS data bursts associated with additional eMBMS data streams without departing from the scope of the present disclosure.

FIG. 3B is a timeline illustrating a paging schedule 350 according to various embodiments. Referring to FIGS. 1 and 3A-B, in various embodiments, the second communication network 164 may transmit paging messages according to the paging schedule 350.

The second communication network 164 may transmit paging messages during a plurality of paging occasions including, for example, but not limited to, a first paging occasion 362 and a second paging occasion 364. In various embodiments, the length of a paging cycle 360 (e.g., 2.56 seconds) associated with the second communication network 164 may be a length of time between two consecutive paging occasions. For example, the length of the paging cycle 360 (e.g., 2.56 seconds) may be a length of time between the first paging occasion 362 and the second paging occasion 364.

The length of the paging cycle 360 (e.g., 2.56 seconds) associated with the second communication network 164 may be a multiple of the length of the MSP 315 (e.g., 320 milliseconds) associated with the first communication network 162. As such, paging occasions on the second communication network 164 may coincide with at least some of the eMBMS data bursts broadcast by the first communication network 162.

In some embodiments, paging occasions on the second communication network 164 may coincide with eMBMS data bursts associated with more than one eMBMS data stream. For example, the first paging occasion 362 on the second communication network 164 may coincide with the first data burst 332 of the first eMBMS data stream 310 and the fourth data burst 342 of the second eMBMS data stream 320. The second paging occasion 364 on the second communication network 164 may coincide with the third data burst 336 of the first eMBMS data stream 310 and the sixth data burst 346 of the second eMBMS data stream 320.

As such, tuning away to the second subscription 155 based on the paging schedule 350 may increase the collision metric associated with both the first eMBMS data stream 310 and the second eMBMS data stream 320. For example, both the first eMBMS data stream 310 and the second eMBMS data stream 320 may be associated with one or more of a larger amount of lost eMBMS data, a longer length of lost eMBMS reception time, and a greater number of lost eMBMS sub-frames due to tune-aways to the second subscription 155.

In various embodiments, the control unit 110 may be configured to selectively assign QoS priorities in order to allocate the usage of the RF chain 130 between activities on the first subscription 145 (e.g., eMBMS data reception) and activities on the second subscription 155 (e.g., page reception). For example, the control unit 110 may assign a higher QoS priority to the reception of some but not all of eMBMS data streams on the first subscription 145 based on a collision metric associated with each eMBMS data stream including, for example, but not limited to, an amount (e.g., bytes) of lost eMBMS data, a length of lost eMBMS reception time, and a number of lost eMBMS sub-frames due to tune-aways to the second subscription 155. As such, the mobile communication device 100 may selectively prioritize the reception of some but not all eMBMS data streams on the first subscription 145 and may tune-away to the second subscription 155 for some but not all paging occasions.

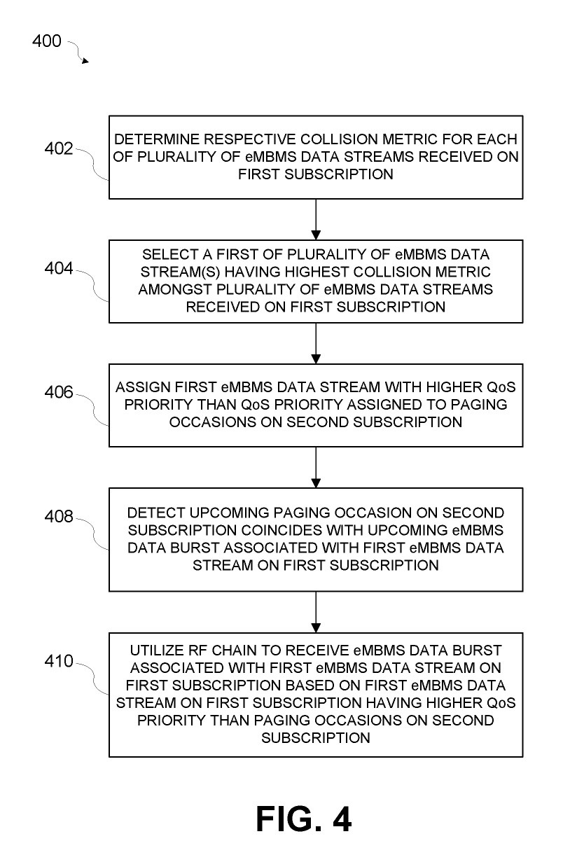

FIG. 4 is a flowchart illustrating a process 400 for selectively prioritizing eMBMS according to various embodiments. Referring to FIGS. 1-4, in various embodiments, the process 400 may be performed by the mobile communication device 100, using, for example, the control unit 110 and/or the QoS module 115.

At block 402, the control unit 110 may determine a respective collision metric associated for each of a plurality of eMBMS data streams received on the first subscription 145. For example, the mobile communication device 100 may have been utilizing the RF chain 130 to receive a plurality of eMBMS data streams on the first subscription 145 from the first communication network 162 including, for example, but not limited to, the first eMBMS data stream 210 and the second eMBMS data stream 220.

Paging occasions on the second subscription 155 may coincide with at least some eMBMS data bursts associated with one or more of the plurality of eMBMS data streams received on the first subscription 145. As such, the mobile communication device 100 may have tuned away to the second subscription 155 during at least some eMBMS data bursts from the first communication network 162 in order to utilize the RF chain 130 to receive one or more paging messages on the second subscription 155 from the second communication network 164.

The control unit 110 may determine, for each of the plurality of eMBMS data streams received on the first subscription 145, a collision metric including, for example, but not limited to, an amount (e.g., bytes) of lost eMBMS data, a length of lost eMBMS reception time, and a number of lost eMBMS sub-frames due to tune-aways to the second subscription 155.

At block 404, the control unit 110 may select a first of the plurality of eMBMS data streams having a highest collision metric amongst the plurality of eMBMS data streams received on the first subscription 145. At block 406, the control unit 110 may assign the first eMBMS data stream with a higher QoS priority than a QoS priority assigned to paging occasions on the second subscription 155.

For example, the control unit 110 may select the first eMBMS data stream 210 if the first eMBMS data stream 210 has a higher collision metric than the other eMBMS data streams received on the first subscription 145 including, for example, but not limited to, the second eMBMS data stream 220. The first eMBMS data stream 210 may have the largest amount of lost eMBMS data, longest period of lost eMBMS reception time, and/or highest number of lost eMBMS sub-frames due to tune-aways to the second subscription 155. As such, the control unit 110 may assign the first eMBMS data stream 210 a QoS priority that causes the control unit 110 to prioritize the reception of the first eMBMS data stream 210 on the first subscription 145 over the reception of paging messages on the second subscription 155. For example, if the collision time for service 0 is 80 ms and the collision time for service 1 is 0 ms, service 0 may use a higher QoS, while service 1 does not use a higher QoS.

In some embodiments, more than one eMBMS data stream may have the highest collision metric amongst the plurality of eMBMS data streams. For example, both the first eMBMS data stream 210 and the second eMBMS data stream 220 may have the largest amount of lost eMBMS data, longest period of lost eMBMS reception time, and/or highest number of lost eMBMS sub-frames due to tune-aways to the second subscription 155. As such, the control unit 110 may arbitrarily select the first eMBMS data stream 210 and assign the first eMBMS data stream 210 but not the second eMBMS data stream 220 with a higher QoS priority. Alternately, the control unit 110 may arbitrarily select the second eMBMS data stream 220 and assign the second eMBMS data stream 220 but not the first eMBMS data stream 210 with a higher QoS priority.

At block 408, the control unit 110 may detect that an upcoming paging occasion on the second subscription 155 coincides with an upcoming eMBMS data burst associated with the first eMBMS data stream on the first subscription 145. In response to detecting that an upcoming paging occasion on the second subscription 155 coincides with an upcoming eMBMS data burst associated with the first eMBMS data stream on the first subscription 145, at block 410 the control unit 110 may utilize the RF chain 130 to receive the eMBMS data burst associated with the first eMBMS data stream on the first subscription 145 based at least in part on the first eMBMS data stream on the first subscription 145 having a higher QoS priority than the paging occasions on the second subscription 155.

When an eMBMS data burst scheduled on the first subscription 145 coincides with a paging occasion on the second subscription 155, the control unit 110 may allocate the RF chain 130 based on the QoS priority assigned to the corresponding eMBMS data stream on the first subscription 145 and the QoS priority assigned to paging occasions on the second subscription 155. For example, based on the higher QoS priority associated with the first eMBMS data stream 210 on the first subscription 145, the control unit 110 may utilize the RF chain 130 to receive the eMBMS data burst on the first subscription 145 instead of tuning away to the second subscription 155. As such, the control unit 110 may disregard the upcoming paging occasion on the second subscription 155.

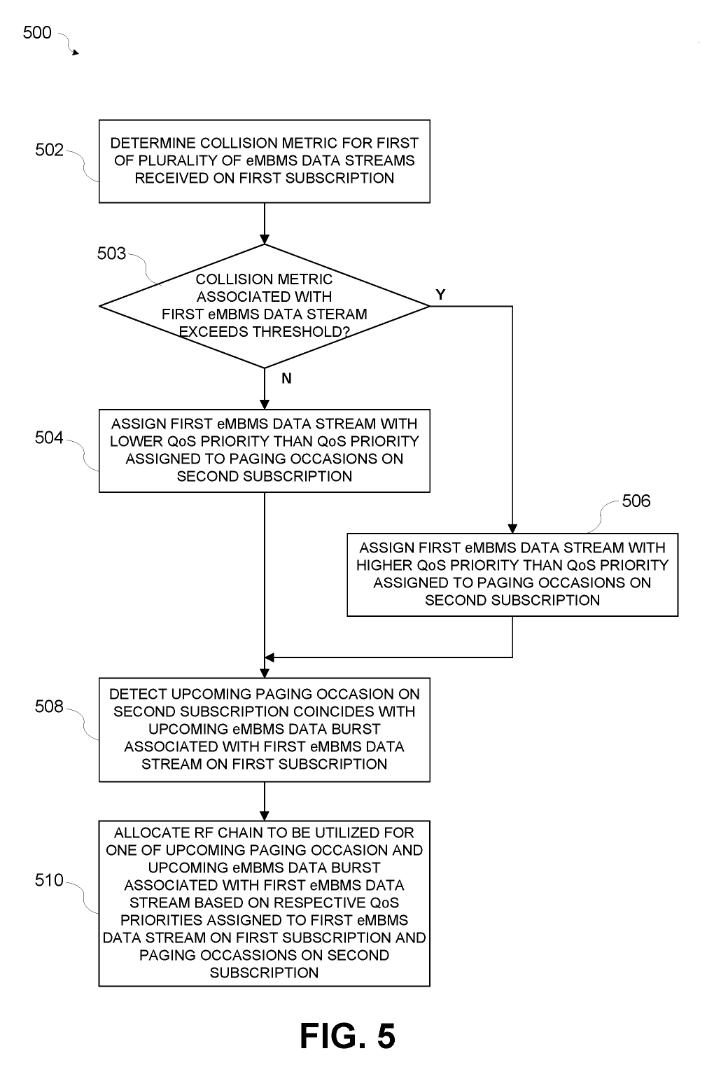

FIG. 5 is a flowchart illustrating a process 500 for selectively prioritizing eMBMS according to various embodiments. Referring to FIGS. 1-5, in various embodiments, the process 500 may be performed by the mobile communication device 100, using, for example, the control unit 110, and/or the QoS module 115.

At block 502, the control unit 110 may determine a collision metric associated with a first of a plurality of eMBMS data streams received on the first subscription 145. For example, the mobile communication device 100 may have been utilizing the RF chain 130 to receive a plurality of eMBMS data streams on the first subscription 145 from the first communication network 162 including, for example, but not limited to, the first eMBMS data stream 210.

Paging occasions on the second subscription 155 may coincide with at least some eMBMS data bursts associated with one or more of the plurality of eMBMS data streams received on the first subscription 145 (e.g., the first eMBMS data stream 210). As such, the mobile communication device 100 may have tuned away to the second subscription 155 during at least some eMBMS data bursts from the first communication network 162 in order to utilize the RF chain 130 to receive one or more paging messages on the second subscription 155 from the second communication network 164.

The control unit 110 may determine a collision metric for the first eMBMS data stream 210 including, for example, but not limited to, an amount (e.g., bytes) of lost eMBMS data, a length of lost eMBMS reception time, and a number of lost eMBMS sub-frames due to tune-aways to the second subscription 155.

At block 503, the control unit 110 may determine whether the collision metric associated with the first eMBMS data stream 210 exceeds a threshold value. For example, the control unit 110 may determine whether one or more of an amount (e.g., bytes) of lost eMBMS data, a length of lost eMBMS reception time, and a number of lost eMBMS sub-frames associated with the first eMBMS data stream 210 exceeds a threshold value.

If the control unit 110 determines that the collision metric associated with the first eMBMS data stream does not exceed a threshold value (503-N), at block 504 the control unit 110 may assign the first eMBMS data stream with a lower QoS priority than a QoS assigned to paging occasions on the second subscription 155. For example, if the collision metric associated with the first eMBMS data stream 210 does not exceed the threshold value, the control unit 110 may assign the first eMBMS data stream 210 with a QoS priority that causes the control unit 110 to prioritize reception of paging messages on the second subscription 155 over the reception of the first eMBMS data stream 210 on the first subscription 145.

Alternately, if the control unit 110 determines that the collision metric associated with the first eMBMS data stream exceeds the threshold value (503-Y), at block 506 the control unit 110 may assign the first eMBMS data stream with a higher QoS priority than a QoS assigned to paging occasions on the second subscription 155. For example, if the control unit 110 determines that the collision metric associated with the first eMBMS data stream 210 exceeds the threshold value, then the control unit 110 may assign the first eMBMS data stream 210 with a QoS priority that causes the control unit 110 to prioritize the reception of the first eMBMS data stream 210 on the first subscription 145 over the reception of paging messages on the second subscription 155.

At block 508, the control unit 110 may detect that an upcoming paging occasion on the second subscription 155 coincides with an upcoming eMBMS data burst associated with the first eMBMS data stream on the first subscription. At block 510, the control unit 110 may allocate the RF chain 130 to be utilized for one of the upcoming paging occasion and the upcoming eMBMS data burst associated with the first eMBMS data stream based at least in part on the respective QoS priorities assigned to the first eMBMS data stream on the first subscription 145 and paging occasions on the second subscription 155.

For example, if the collision metric associated with the first eMBMS data stream 210 exceeds the threshold value, the control unit 110 may utilize the RF chain 130 to receive the eMBMS data burst associated with the first eMBMS data stream 210 on the first subscription 145 instead of tuning away to the second subscription 155. As such, the control unit 110 may disregard the upcoming paging reception on the second subscription 155.

Alternately, if the collision metric associated with the first eMBMS data stream 210 does not exceed the threshold value, the control unit 110 may tune away to the second subscription 155 during the upcoming eMBMS data burst in order to utilize the RF chain 130 to receive paging messages on the second subscription 155. As such, the control unit 110 may disregard the upcoming eMBMS data burst associated with the first eMBMS data stream 210 on the first subscription 145.

In some embodiments, more than one eMBMS data streams received on the first subscription 145 may be associated with a collision metric that exceeds the threshold value. As such, more than one eMBMS data stream on the first subscription 145 may be assigned a higher QoS priority than the QoS assigned to paging occasions on the second subscription 155. For example, if the collision metric associated with the first eMBMS data stream 210 and the second eMBMS data stream 220 both exceed the threshold value, the control unit 110 may assign a higher QoS priority to both the first eMBMS data stream 210 and the second eMBMS data stream 220. Accordingly, the control unit 110 may prioritize eMBMS data bursts associated with both the first eMBMS data stream 210 and the second eMBMS data stream 220 when such eMBMS data bursts coincide with paging occasions on the second subscription 155.

Alternatively, only one eMBMS data stream on the first subscription 145 may have a collision metric that exceeds a threshold. For example, if the collision time for service 0 is 60 ms, the collision time for service 1 is 20 ms, and the threshold is 40 ms, service 0 may use a higher QoS, while service 1 does not use a higher QoS.

For example, if a first collision metric C₁ associated with the first eMBMS data stream 210 is 60 milliseconds, a second collision metric C₂ associated with the second eMBMS data stream 220 is 45 milliseconds, and the threshold value Cₜ is 40 milliseconds, then the control unit 110 may assign a higher QoS priority to both the first eMBMS data stream 210 and the second eMBMS data stream 220.

The accompanying claims and their equivalents are intended to cover such forms or modifications as would fall within the scope and spirit of the protection. For example, the example apparatuses, methods, and systems disclosed herein may be applied to multi-SIM wireless devices subscribing to multiple communication networks and/or communication technologies. The various components illustrated in the figures may be implemented as, for example, but not limited to, software and/or firmware on a processor, ASIC/FPGA/DSP, or dedicated hardware. Also, the features and attributes of the specific example embodiments disclosed above may be combined in different ways to form additional embodiments, all of which fall within the scope of the present disclosure.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc., are not intended to limit the order of the operations; these words are simply used to guide the reader through the description of the methods. Further, any reference to claim elements in the singular, for example, using the articles “a,” “an,” or “the” is not to be construed as limiting the element to the singular.

The various illustrative logical blocks, modules, circuits, and operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The hardware used to implement the various illustrative logics, logical blocks, modules, and circuits described in connection with the various embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in processor-executable instructions that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include random access memory (RAM), read-only memory (ROM), electrically erasable programmable read-only memory (EEPROM), FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

Although the present disclosure provides certain example embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined by reference to the appended claims.

What is claimed is:

1. A method for selectively prioritizing evolved multimedia broadcast multicast services (eMBMS) by a mobile communication device having a radio-frequency (RF) chain associated with a first subscription and a second subscription, the method comprising:
determining a collision metric associated with at least one of a plurality of eMBMS data streams received on the first subscription;
identifying a first eMBMS data stream of the plurality of eMBMS data streams having a highest collision metric amongst the plurality of eMBMS data streams received on the first subscription;
assigning the first eMBMS data stream with a higher quality of service (QoS) priority than a QoS priority assigned to paging occasions on the second subscription;
detecting that an upcoming paging occasion on the second subscription coincides with an upcoming eMBMS data burst associated with the first eMBMS data stream on the first subscription; and
in response to detecting that the upcoming paging occasion on the second subscription coincides with the upcoming eMBMS data burst associated with the first eMBMS data stream on the first subscription, utilizing the RF chain to receive an eMBMS data burst associated with the first eMBMS data stream on the first subscription based at least in part on the first eMBMS data stream on the first subscription having a higher QoS priority than the paging occasions on the second subscription.

2. The method of claim 1, wherein the collision metric comprises one or more of an amount of lost eMBMS data, a length of lost eMBMS reception time, and a number of lost eMBMS sub-frames due to tuning away to utilize the RF chain to receive one or more paging messages on the second subscription.

3. The method of claim 1, further comprising assigning a second eMBMS data stream of the plurality of eMBMS data streams on the first subscription with a lower QoS priority than the QoS assigned to the paging occasions on the second subscription.

4. The method of claim 3, further comprising:
detecting that another upcoming paging occasion on the second subscription coincides with an upcoming eMBMS data burst associated with the second eMBMS data stream on the first subscription; and
in response to detecting that the another upcoming paging occasion on the second subscription coincides with an upcoming eMBMS data burst on the first subscription, tuning away to the second subscription in order to utilize the RF chain to receive one or more paging messages on the second subscription based at least in part on the paging occasions on the second subscription having a higher QoS priority than the second eMBMS data stream on the first subscription.

5. The method of claim 3, wherein the second eMBMS data stream is associated with a lower collision metric than the first eMBMS data stream due to the paging occasions on the second subscription coinciding with a larger number of eMBMS data bursts associated with the first eMBMS data stream than eMBMS data bursts associated with the second eMBMS data stream.

6. The method of claim 3, wherein:
each of the first eMBMS data stream and the second eMBMS data stream comprises a plurality of segments of data;
each segment of data comprises a plurality of consecutive eMBMS data bursts; and
the second eMBMS data stream is associated with a lower collision metric than the first eMBMS data stream due to the paging occasions on the second subscription coinciding with eMBMS data bursts that are substantially at an end of at least some of the plurality of segments of data comprising the first eMBMS data stream and with eMBMS data bursts that are substantially at a beginning of at least some of the plurality of segments of data comprising the second eMBMS data stream.

7. The method of claim 1, further comprising arbitrarily selecting the first eMBMS data stream to assign a higher QoS priority than the QoS priority assigned to the paging occasions on the second subscription when both the first eMBMS data stream and a second eMBMS data stream of the plurality of eMBMS data streams on the first subscription are associated with the highest collision metric amongst the plurality of eMBMS data streams received on the first subscription.

8. A mobile communication device, comprising:
a radio frequency (RF) chain;
a memory operably connected to said RF chain; and
a control unit operably connected to said RF chain and configured to:
determine a collision metric associated with at least one of a plurality of evolved multimedia broadcast multicast service (eMBMS) data streams received on a first subscription;
identify a first eMBMS data stream of the plurality of eMBMS data streams having a highest collision metric amongst the plurality of eMBMS data streams received on the first subscription;
assign the first eMBMS data stream with a higher quality of service (QoS) priority than a QoS priority assigned to paging occasions on a second subscription;
detect that an upcoming paging occasion on the second subscription coincides with an upcoming eMBMS data burst associated with the first eMBMS data stream on the first subscription; and
in response to detecting that the upcoming paging occasion on the second subscription coincides with the upcoming eMBMS data burst associated with the first eMBMS data stream on the first subscription, utilize the RF chain to receive an eMBMS data burst associated with the first eMBMS data stream on the first subscription based at least in part on the first eMBMS data stream on the first subscription having a higher QoS priority than the paging occasions on the second subscription.

9. The mobile communication device of claim 8, wherein the collision metric comprises one or more of an amount of lost eMBMS data, a length of lost eMBMS reception time, and a number of lost eMBMS sub-frames due to the control unit tuning away to utilize the RF chain to receive one or more paging messages on the second subscription.

10. The mobile communication device of claim 8, wherein the control unit is further configured to assign a second eMBMS data stream of the plurality of eMBMS data streams on the first subscription with a lower QoS priority than the QoS assigned to the paging occasions on the second subscription.

11. The mobile communication device of claim 10, wherein the control unit is further configured to:
detect that another upcoming paging occasion on the second subscription coincides with an upcoming eMBMS data burst associated with the second eMBMS data stream on the first subscription; and
in response to detecting that the another upcoming paging occasion on the second subscription coincides with an upcoming eMBMS data burst on the first subscription, tune away to the second subscription in order to utilize the RF chain to receive one or more paging messages on the second subscription based at least in part on the paging occasions on the second subscription having a higher QoS priority than the second eMBMS data stream on the first subscription.

12. The mobile communication device of claim 10, wherein the second eMBMS data stream is associated with a lower collision metric than the first eMBMS data stream due to the paging occasions on the second subscription coinciding with a larger number of eMBMS data bursts associated with the first eMBMS data stream than eMBMS data bursts associated with the second eMBMS data stream.

13. The mobile communication device of claim 10, wherein:
each of the first eMBMS data stream and the second eMBMS data stream comprises a plurality of segments of data;
each segment of data comprises a plurality of consecutive eMBMS data bursts; and
the second eMBMS data stream is associated with a lower collision metric than the first eMBMS data stream due to the paging occasions on the second subscription coinciding with eMBMS data bursts that are substantially at an end of at least some of the plurality of segments of data comprising the first eMBMS data stream and with eMBMS data bursts that are substantially at a beginning of at least some of the plurality of segments of data comprising the second eMBMS data stream.

14. The mobile communication device of claim 8, wherein the control unit is further configured to arbitrarily select the first eMBMS data stream to assign a higher QoS priority than the QoS priority assigned to the paging occasions on the second subscription when both the first eMBMS data stream and a second eMBMS data stream of the plurality of eMBMS data streams on the first subscription are associated with the highest collision metric amongst the plurality of eMBMS data streams received on the first subscription.

15. A method for selectively prioritizing evolved multimedia broadcast multicast services (eMBMS) by a mobile communication device having a radio-frequency (RF) chain associated with a first subscription and a second subscription, comprising:
determining a collision metric associated with a first eMBMS data stream received on the first subscription;
determining whether the collision metric associated with the first eMBMS data stream exceeds a threshold value;
in response to determining that the collision metric associated with the first eMBMS data stream exceeds the threshold value, assigning the first eMBMS data stream with a higher quality of service (QoS) priority than a QoS priority assigned to paging occasions on the second subscription;
detecting that an upcoming paging occasion on the second subscription coincides with an upcoming eMBMS data burst associated with the first eMBMS data stream on the first subscription; and
allocating the RF chain to be utilized for one of the upcoming paging occasion and the upcoming eMBMS data burst based at least in part on the respective QoS priorities assigned to the first eMBMS data stream on the first subscription and the paging occasions on the second subscription.

16. The method of claim 15, further comprising in response to determining that the collision metric associated with the first eMBMS data stream does not exceed the threshold value, assigning the first eMBMS data stream with a lower QoS priority than the QoS priority assigned to the paging occasions on the second subscription.

17. The method of claim 15, wherein allocating the RF chain based at least in part on the respective QoS priorities assigned to the first eMBMS data stream on the first subscription and the paging occasions on the second subscription comprises utilizing the RF chain to receive the upcoming paging occasion on the first subscription when the first eMBMS data stream is assigned a higher QoS priority than the paging occasions on the second subscription.

18. The method of claim 17, wherein allocating the RF chain based at least in part on the respective QoS priorities assigned to the first eMBMS data stream on the first subscription and the paging occasions on the second subscription further comprises tuning away to the second subscription to utilize the RF chain to receive one or more paging messages on the second subscription when the paging occasions on the second subscription is assigned a higher QoS priority than the first eMBMS data stream.

19. The method of claim 15, wherein the collision metric comprises one or more of an amount of lost eMBMS data, a length of lost eMBMS reception time, and a number of lost eMBMS sub-frames due to tuning away to utilize the RF chain to receive one or more paging messages on the second subscription.

20. A mobile communication device, comprising:
a radio frequency (RF) chain;
a memory operably connected to said RF chain; and
a control unit operably connected to said RF chain and configured to:
determine a collision metric associated with a first eMBMS data stream received on a first subscription;
determine whether the collision metric associated with the first eMBMS data stream exceeds a threshold value;
in response to determining that the collision metric associated with the first eMBMS data stream exceeds the threshold value, assign the first eMBMS data stream with a higher quality of service (QoS) priority than a QoS priority assigned to paging occasions on a second subscription;
detect that an upcoming paging occasion on the second subscription coincides with an upcoming eMBMS data burst associated with the first eMBMS data stream on the first subscription; and
allocate the RF chain to be utilized for one of the upcoming paging occasion and the upcoming eMBMS data burst based at least in part on the respective QoS priorities assigned to the first eMBMS data stream on the first subscription and the paging occasions on the second subscription.
